(19) United States
(12) Patent Application Publication
(10) Pub. No.: US 2013/0203464 A1
(43) Pub. Date: Aug. 8, 2013

(54) Radar/laser emission Detecting cell phone attachment device

(71) Applicant: Devaraj Thiruppathi, Columbus, GA (US)

(72) Inventor: Devaraj Thiruppathi, Columbus, GA (US)

(21) Appl. No.: 13/385,197

(22) Filed: Feb. 6, 2012

(51) Int. Cl. H04W 88/02

(52) U.S. Cl. 455/557

(57) ABSTRACT

A radar/laser emission detecting unit which is an attachment to a personal cell phone, wherein the emission detector unit can only detect the radar and laser emissions, process the signal and transfer the signal to the personal cell phone containing a software application which interprets the signal and displays the warning through an audio unit and a display unit which can be seen and heard by the driver.

### FIELD OF THE INVENTION

The present invention relates to a radar and laser detector, particularly a radar and laser detector used as an attachment to a personal cell phone. The invention relates to an emission detector unit being able to attach to a personal cell phone, whereby allowing the driver to be warned of potential emissions, from police, to track the speed of a vehicle, through a software applications loaded onto the personal cell phone.

### BACKGROUND OF THE INVENTION

Radar or laser detectors are well known in the industry to warn drivers of police radar or laser emission to avoid citations for exceeding the speed limit. Radar detectors detect radio frequency emissions in a given frequency range. Laser detectors detect an impinging laser beam directed toward the detector. Modern detectors comprise of both radar and laser detection. A typical radar or laser detector assembly includes a detection means, a processing means and a displaying means. A detection means detects the radar or laser emissions, a processing means processes the signals from the detection and the displaying means displays the information in audible or visual form. The radar or laser detectors warns the driver by emitting audible and/or visible warning indicating the detection of radar impinging on the radar device. The radar or laser detectors are often small and their power needs are relatively small and can last for 60 to 90 days on two AA 1.5 v cell batteries or can have a power cord attached to obtain power from the vehicle. The bands used by police radar are generally known as the X, K and Ka bands. Each relates to a different part of the spectrum. The X and K bands are relatively narrow frequency range, whereas the Ka band is a relatively wide range of frequencies. Radar detectors typically comprise of microwave receiver and detector system or circuitry that is typically realized with a microprocessor or digital signal processor. Police also use laser systems for detecting speed and the technology was termed LIDAR “Light Detection and Ranging”. The digital signal processor or microprocessor in a modern radar detector is programmable. Accordingly, they can be instructed to manage all of the user interface features such as input switches, lights, sounds, as well as generate control and timing signals for the microwave receiver and/or laser detector.

The radar industry has increased in the use of technology and performance whereby increasing the cost in purchasing the device unlike the cellular phone industry. The cellular telephone industry is currently in its third generation with several types of cellular telephone systems. The cellular market in the United States grew from about 2 million subscribers and $2 billion in revenue in 1988 to more than 60 million subscribers and about $30 billion in revenue in 1998 and the growth is continuing in the United States and also around the world. As the technology increases and services becoming more available, such as wireless communication networking, internet connectivity and GPS tracking and mapping the subscribers also increased in proportion, whereby reducing cost and price, making the high technology available for everyone. Therefore a need exists to reduce the cost of detection by reducing the components in the radar and laser detector. The reduction is obtained by only including the detection means and processing means components that detect the radar and laser emissions and a detector system for recognizing, transferring and receiving the signals in the radar and laser detector. The displaying means such as the microprocessor component, audio and visual components are already in the personal cell phones, therefore reducing the cost and increasing the performance of the radar and laser detector. The reduction in cost and increased performance and service can be obtained by using an independently functioning external device, such as the personal cell phone, and integrating it to the radar, laser, or a radar and laser detecting unit, whereby allowing the radar and laser detection unit to become an attachment to the personal cell phone.

### SUMMARY OF THE INVENTION

The present invention is a radar/laser detecting cell phone attachment device, which is composed of an emission detector unit and an independently functioning external device, such as a personal cell phone. An independently functioning external device is any device that has other uses. The emission detector unit includes only a means for detecting an emission and a means for processing a signal, which was generated due to the detection of an emission. The personal cell phone includes a means for displaying a signal from the emission detection unit. A microprocessor, audible, visible and software components are already located on the personal cell phone. The personal cell phone such as smartphone, is a height tech device already containing components and programs such as web connection, GPS and other software, whereby reducing the cost and enhancing the performance of the radar and laser detector.

The radar/laser detecting cell phone attachment device comprises an emission detector unit, which detects the radar or laser emitted by the police to detect the speed of the vehicle. The emission detector unit includes means for detecting an emission, which is composed of a radar unit and a laser unit, which detects emission such as microwave and infrared emission to detect speed of a vehicle and includes means for processing a signal, which is composed of a signal processor, which processes the signal received by the radar and laser units and includes a means for transferring a signal, which is composed of a information transmitter and receiver unit and a connector unit which transfers the signal to the external device, such as the personal cell phone.

The emission detector unit is dependent on the personal cell phone and cannot independently warn the driver of any radar or laser emissions. The emission detector unit is powered by either an internal power source, which are batteries or an external power source form the vehicle.

The emission detector unit communicates to the personal cell phone directly through a communication cord or through wireless connection. The personal cell phone can only communicate with the emission detector unit if a software application is downloaded onto the cell phone from the web or is already installed onto the phone. This download is accomplished through the typical means for communicating downloads and is coordinated through a transmitter and receiver unit and a microprocessor unit. The microprocessor unit through means for coordinating, coordinates information from the software application and displaying through means for displaying on the display screen and audio output.

The emission detector unit communicates with the software application through means for transferring a signal either directly or through wireless communication. Direct communication is through the connector unit, which includes a detector communication port located on the emission detector unit and a communication unit, which includes the cell phone communication port located on the personal cell phone. A communication cord connects to the detector communication port and the cell phone communication port to facilitate transfer of data. Wireless communication is through the transmitter and receiver unit located on the personal cell phone and an information transmitter and receiver unit located on the emission detector unit.

The emission detector unit is attached to the windshield of a vehicle and the personal cell phone is placed in a holder and placed on top of the dashboard. Once the radar unit or the laser unit detects the emission, the signal is sent to the signal processor and then it is transmitted wirelessly or directly through the information transmitter and receiver unit or connector unit respectively to the transmitter and receiver unit or communication unit on the personal cell phone. The microprocessor unit coordinates activities of the software application installed whereby translating the data to audio and visual warnings, which is heard by the audio output and displayed onto the display screen of the personal cell phone through the audio unit and display unit respectively.

The software application interprets and coordinates the data received in real time from the signal processor and through means for tracking and mapping such as the GPS (Global Positioning System), which shows the position of a moving vehicle and coordinating other information from the remote database, such as historical traffic information and photo camera locations, to warn the driver of potential speed traps. Another embodiment of the invention is the enhanced programmability of the radar/laser detecting cell phone attachment device. With the software application and the personal cell phone features available the signal processor can be interfaced to allow for programmability to the desired sensitivity, selection of frequency and others such as blue-tooth capability in the vehicle. The blue-tooth will automatically synchronize with the emission detector unit wirelessly.

Yet another embodiment of the radar/laser detecting cell phone attachment device is the ability to obtain real time detection of police radar and laser emissions located on a remote database. The software application, with GPS capabilities and web connectivity, present on the personal cell phone, in real time stores the detections of police radar and laser detection on the remote database, which can be accessed by all individuals, who are capable of downloading the software application onto their personal cell phone.

Therefore a vehicle that does not have the radar/laser detecting cell phone attachment device can also obtain the police emission data stored in the remote database. For example, a first vehicle having the radar/laser detecting cell phone attachment device and a second vehicle not having the radar/laser detecting cell phone attachment device traveling a few yards or miles behind the first vehicle can also obtain the warning of the detection of the police radar or laser emission in real time from data stored in remote database with respect to its location with the GPS. The disadvantage being when the radar or laser gun is pointed towards the second vehicle, wherein the second vehicle does not have the ability to detect the police radar or laser by itself therefore increasing potential of a speeding citation if traveling above the speed limit.

These and other objects, features and advantages of the present invention will become apparent from the following detailed description. It should be understood, however, that the detailed description and the specific examples, while indicating preferred embodiments of the invention, are given by way of illustrations only, since various changes and modifications within the spirit and scope of the invention will become apparent to those skilled in the art.

### BRIEF DESCRIPTION OF THE DRAWINGS

The present invention will become more fully understood from the detailed description given herein below and the accompanying drawings, which are given by way of illustration only and are not limitative of the present invention, wherein:

FIG. 1 is a perspective representational view of a radar/laser detecting cell phone attachment device composed of an emission detector unit and a personal cell phone connected by a communication cord;

FIG. 2 is a front perspective view of the emission detector unit;

FIG. 3 is a block diagram of the emission detector unit;

FIG. 4 is a block diagram of the emission detector unit with an information transmitter and receiver unit;

FIG. 5 is a perspective view of a personal cell phone device;

FIG. 6 is a block diagram of the personal cell phone device;

FIG. 7 is an illustrative view of radar/laser detecting cell phone attachment device and cell phone device.

### DETAILED DESCRIPTION OF THE PREFERRED EMBODIMENT

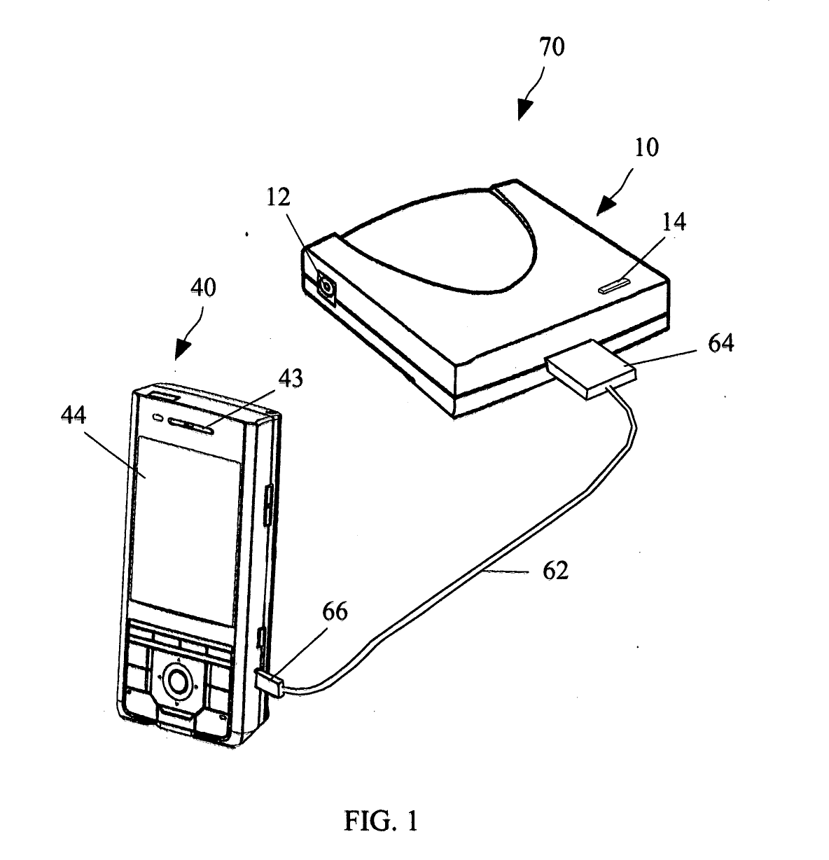

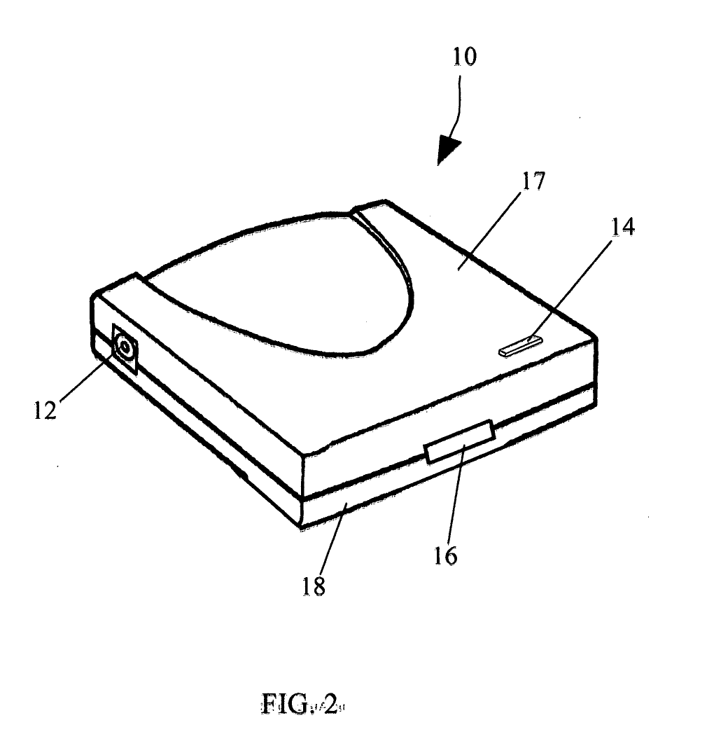

Referring now to the drawings wherein the depictions are for purposes of illustrating a preferred embodiment of the present invention only and not for the purpose of limiting the same. FIG. 1 is a representational view showing an embodiment of a radar/laser detecting cell phone attachment device 70. The radar/laser detecting cell phone attachment device 70 is composed of an emission detector unit 10 and a personal cell phone 40. The personal cell phone 40 is an independently functioning external device, its primary purpose being cellular communication, whereas the emission detector unit 10 is dependent on the personal cell phone 40 to display the signal, whereby becoming an accessory attachment to the personal cell phone 40 to be able to function as a complete radar and laser detector. FIG. 2 is a front perspective view of the emission detector unit 10. The emission detector unit 10 is composed of a top cover 17, a bottom cover 18 and between the covers is located a detector system 20 or a wireless detector system 30. The top cover 17 contains a on/off switch 14 and located on the sides of the top cover 17 and bottom cover 18 is a power pin 12 and a detector communication port 16. The on/off switch 14 turns the emission detector unit 10 on and off allowing it to operate. The power pin 12 connects to an outside power source to obtain power to operate. The emission detector 10 also contains an internal power source such as batteries. The detector communication port 16 allows the emission detector unit 10 to communicate with an external device such as the personal cell phone 40.

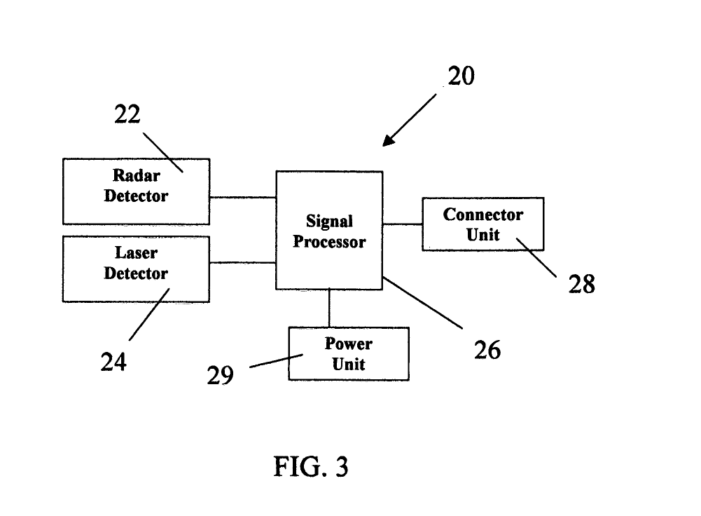

The emission detector unit 10 contains components and circuitry necessary, for detecting radar and laser emissions emitted by police to detect speed of vehicles. FIG. 3 is a block diagram of the emission detector unit 10. The detector system 20 is a system for detecting radar and laser emissions and is composed of a power unit 29, for obtaining power and the means for detecting an emission is, a radar detector 22 and a laser detector 24 and a signal processor 26, through means for processing a signal, detected from the radar detector 22 and laser detector 24 and through means for transferring a signal, which was detected is, through a connector unit 28 to an external device. The emission detector unit 10 only contains the minimum components, which are the means for detecting the radar and laser emissions and means for processing and means for transferring the signals to an external device. There are on means for displaying a signal from the detection of the radar and laser emissions to the driver in the emission detector unit 10.

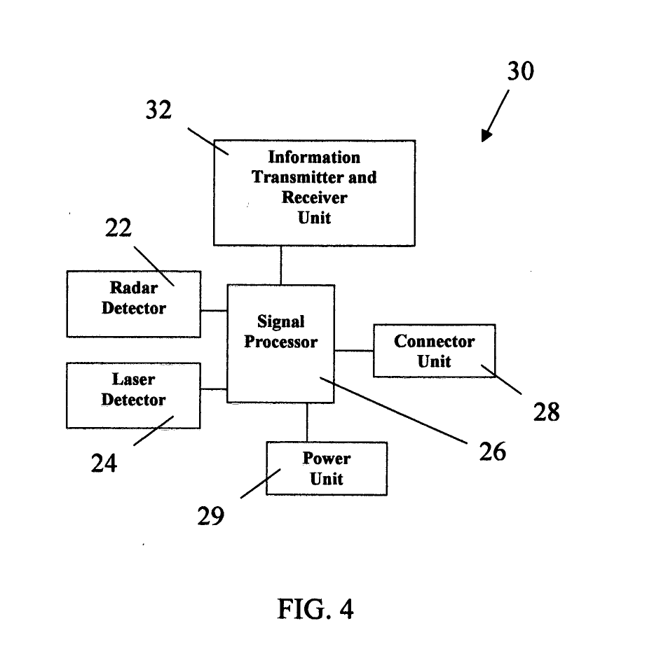

FIG. 4 is a block diagram of the emission detector unit 10 with an information transmitter and receiver unit 32. The wireless detector system 30 is a system for detecting radar and laser emissions as in the detector system 20 except with an addition of the information transmitter and receiver unit 32. The information transmitter and receiver unit 32 is responsible for the means for transferring a signal through wireless communication. The wireless communication is to an external device, such as the personal cell phone 40.

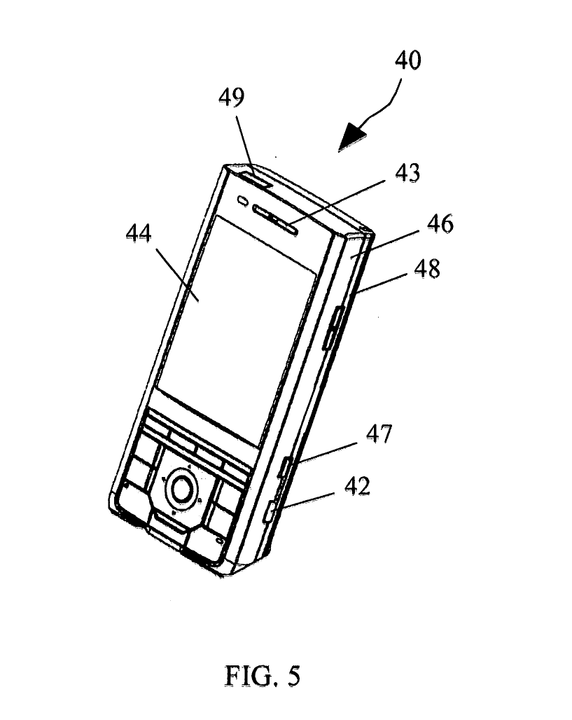

FIG. 5 is a perspective view of the personal cell phone 40. The cell phone 40 is composed of a top phone cover 46, a bottom phone cover 48 and located in between is a cell phone system 50. A cell on/off switch 49 is located on the top side of personal cell phone 40 and allows the personal cell phone 40 to be turned on and off. There are two types of power supplies to the personal cell phone 40, an internal power supply, which are batteries and an external power supply, which is obtained from the vehicle and connected to a cell power pin 47. An audio output 43 is located on the top phone cover 46. The audio output 43 acts as an audio warning indicator to the driver that radar and laser emissions by the police are being detected and the driver should be aware of the speed limit. A display screen unit 44 is also located on the top phone cover 46 and acts as a visual warning indicator to the driver that radar and laser emissions by the police are being detected and the driver should be aware of the speed limit. Through means for displaying a signal from the detection of the radar and laser emission, the driver can be warned by both the audio output 43 and the display screen unit 44. The audio and visual warning are only operational if a software application 57 is downloaded onto the personal cell phone 40 or is already installed onto the personal cell phone 40.

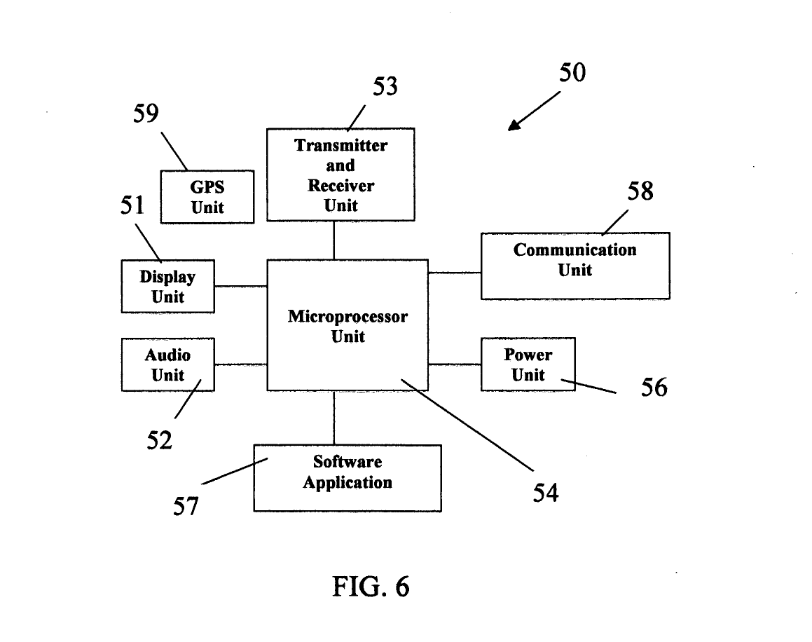

FIG. 6 is a block diagram of the cell phone system 50. The software application 57 can be downloaded through means for communicating by a transmitter and receiver unit 53 through wireless communication from a remote database. The means for communicating begin through cellular, internet or satellite communication for transferring information to and from the personal cell phone 40. The transmitter and receiver unit 53 can also communicate to the emission detector unit 10 through means for communicating, utilizing the blue tooth feature of a typical cell phone. The software application 57 contains programs, which allows the personal cell phone 40 to communicate with the emission detector unit 10.

Once a radar and laser emission is detected by the radar detector 22 or a laser detector 24, a signal is sent to the signal processor 26. The signal processor 26 processes the signals and sends signals through the connector unit 28 located in the emission detector unit 10 through the communication cord 62 as depicted in FIG. 1. The communication cord 62 at one end contains a detector cord pin 64 which attaches to the detector communication port 16 represented by the connector unit 28 located on the emission detector unit 10 and the other end contains a cell phone cord pin 66 which attaches to the cell phone communication port 42 represented by the communication unit 58 located in the personal cell phone 40. The software application 57 can also through means for communicating, communicate wirelessly through the transmitter and receiver unit 53 located in the personal cell phone 40 to the information transmitter and receiver unit 32 located on the emission detector unit 10. The cell phone system 50 also contains a GPS unit 59, which is a global positioning system through means for tracking and mapping allows the personal cell phone 40 to be tracked while the vehicle is moving, therefore allowing the vehicle to be tracked and whereby obtaining the real time traffic information and radar and laser emission warnings whereby through means for displaying, displays a signal onto the display screen unit 44 and audio output 43 and respectively through a display unit 51 and an audio unit 52. The radar and laser emissions can also be saved in real time in a remote database with the coordination of the emission detector unit 10, the software application 57 and the transmitter and receiver unit 53 through wireless communication to a remoter database. The microprocessor unit 54 through means for coordinating, coordinates all activities, which are regulated by the software application 57 in the personal cell phone 40. A power unit 56 allows the personal cell phone 40 to obtain power through battery or corded means.

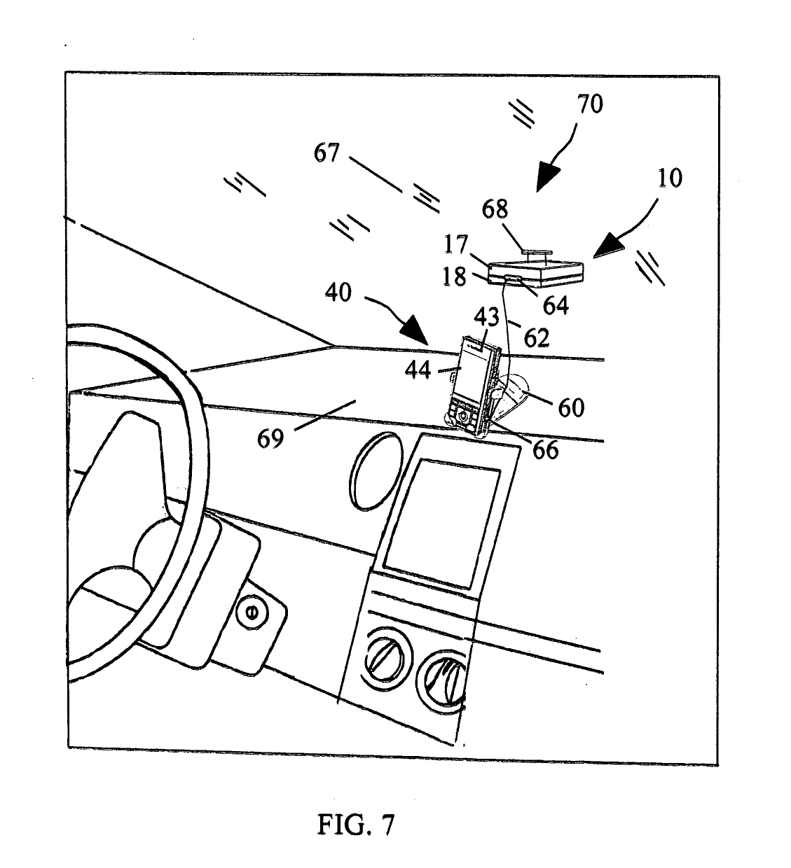

FIG. 7 is an illustrative view of the radar and laser detecting cell phone attachment device 70 whereby the emission detector unit 10 is attached to a windshield 67 of a vehicle with a suction cup 68 and the personal cell phone 40 is placed in a cell phone holder 60 and attached to the top of a dashboard 69. A wired connection is depicted in FIG. 7 of the emission detector unit 10 being connected to the personal cell phone 40 by the communication cord 62. A wireless connection between the emission detector unit 10 and the personal cell phone 40 can also be utilized if desired.

What is claimed is:

1) A radar and laser detecting cell phone attachment device comprising:
a) means for detecting an emission, wherein said emission is generated by a speed detection unit;
b) means for processing a signal, which was detected;
c) means for transferring a signal, which was detected to an external device, wherein said external device can independently function having other use;
d) a power unit;

2) The radar and laser detecting cell phone attachment device of claim 1, wherein said external device includes means for displaying a signal.

3) The radar and laser detecting cell phone attachment device of claim 2, wherein said external device includes a software application.

4) The radar and laser detecting cell phone attachment device of claim 3, wherein said means for displaying a signal is through a display screen unit and an audio output.

5) The radar and laser detecting cell phone attachment device of claim 4, wherein said external device includes means for communicating, which is wireless communication to a remote database and other units whereby said software application and other data can be wirelessly transferred.

6) The radar and laser detecting cell phone attachment device of claim 5, wherein said external device includes means for coordinating signals from said software application.

7) The radar and laser detecting cell phone attachment device of claim 6, wherein said external device has means for tracking and mapping.

8) The radar and laser detecting cell phone attachment device of claim 7, wherein said external device is a personal cell phone.

9) The radar and laser detecting cell phone attachment device of claim 8, wherein said means for detecting an emission is a radar unit and laser unit.

10) The radar and laser detecting cell phone attachment device of claim 9, wherein said means for processing a signal is a signal processor.

11) The radar and laser detecting cell phone attachment device of claim 9, wherein said means for transferring a signal is an information transmitter unit and a connector unit.

12) A radar and laser detecting cell phone attachment comprising:
a) a emission detector unit containing;
(i) means for detecting an emission, which is generated by a speed detection unit;
(ii) means for processing a signal, which was detected;
(iii) means for transferring a signal, which was detected;
(iv) a power unit
b) an external device, being able to independently function having other uses;

13) The radar and laser detecting cell phone attachment of claim 12, wherein said means for detecting an emission is a radar detector and a laser detector.

14) The radar and laser detecting cell phone attachment of claim 13, wherein said means for processing a signal is signal processor.

15) The radar and laser detecting cell phone attachment of claim 14, wherein said means for transferring a signal is an information transmitter and receiver unit and a connector unit.

16) The radar and laser detecting cell phone attachment of claim 15, wherein said external device comprising;
(i) means for displaying a signal, which was detected;
(ii) means for communicating;
(iii) means for coordinating;
(iv) means for tracking and mapping;
(v) a power unit.

17) The radar and laser detecting cell phone attachment device of claim 16, wherein said external device includes a software application through said means for communicating is wirelessly downloaded and includes a GPS unit through said means for tracking and mapping generate a real time location.

18) The radar and laser detecting cell phone attachment of claim 17, wherein said means for displaying a signal is a display unit and a audio unit and said means for coordinating is a microprocessor unit which coordinates signals for said software application.

19) The radar and laser detecting cell phone attachment of claim 18, wherein said external device is a personal cell phone.

20) A radar and laser detecting cell phone attachment comprising:
(1) a emission detector unit containing;
a. means for detecting an emission generated by a speed detection unit is a radar detector and a laser detector;
b. means for processing a signal, which was detected is by a signal processor;
c. means for transferring a signal, which was detected is through a information transmitter and receiver unit and a connector unit;
d. a power unit;
(2) a personal cell phone;
a. means for displaying a signal, which was detected is through an audio unit and a display unit displaying on an audio output and a display screen unit respectively;
b. means for communicating is through wireless communication wherein a software application is downloaded and allowing communication between said emission detector unit;
c. means for coordinating signal form said software application is a microprocessor;
d. means for tracking and mapping is a GPS unit;
e. a power unit.
